(19) United States
(12) Patent Application Publication
(10) Pub. No.: US 2023/0072952 A1
(43) Pub. Date: Mar. 9, 2023

(54) SYSTEM AND METHOD FOR TESTING A DRIVER ASSISTANCE SYSTEM OF A MOTOR VEHICLE

(71) Applicant: AVL LIST GMBH, Graz (AT)

(72) Inventor: Tobias DUESER, Bühl (DE)

(21) Appl. No.: 17/800,979

(22) PCT Filed: Feb. 19, 2021
(86) PCT No.: PCT/AT2021/060056

§ 371 Date: Aug. 19, 2022

(30) Foreign Application Priority Data
Feb. 20, 2020 (AT) A50121/2020

(51) Int. Cl. B60W 40/02; G01M 17/007

(52) U.S. Cl. CPC B60W 40/02; G01M 17/007; B60W 2420/54; B60W 2420/50

(57) ABSTRACT

A system for testing a driver assistance system of a motor vehicle is provided, wherein the driver assistance system comprises a control unit configured to process sensor signals of at least one environment sensor of the motor vehicle, wherein the environment sensor is configured to detect environmental information and convert it into sensor signals. The system comprises a vehicle test bench configured to operate at least one drive train of the motor vehicle, with at least one simulation module, wherein the simulation module incorporates at least one environment sensor and comprises a stimulation device allocated to said environment sensor. The environment sensor incorporated by in the simulation module corresponds, for example functionally and/or structurally, to the environment sensor of the motor vehicle or is the environment sensor of the motor vehicle. The simulation module is connected to the vehicle test bench in order to transmit a sensor signal from the simulation module to the control unit of the driver assistance system.

The present invention relates to a system for testing a driver assistance system of a motor vehicle and a method for testing a driver assistance system of a motor vehicle on a vehicle test bench.

Modern driver assistance systems have since become widespread by virtue of the comfort and increased driving safety they offer. The development of such systems is increasingly based on the so-called “from road to rig” approach, within the scope of which the driver assistance system tests are not performed in a real environment but rather in a simulated environment.

The “from road to rig” approach is implemented in, for example, so-called “vehicle-in-the-loop” applications in which a vehicle can be operated as if in a real-world environment yet the vehicle's interaction with its environment is simulated and thus generated in a controlled manner. Known for example is the arranging of simulation devices on or in front of sensors on the vehicle which are configured to measure distances in order to simulate objects at different distances from the vehicle. It is thereby possible to test the reactions of a driver assistance system to objects and their distances from the vehicle.

One task of the invention is that of enabling improved testing of a driver assistance system on a vehicle test bench.

This task is solved by a system for testing a driver assistance system of a motor vehicle and a method for testing a driver assistance system of a motor vehicle on a vehicle test bench in accordance with the independent claims.

A first aspect of the invention relates to a system for testing a driver assistance system of a motor vehicle, whereby a driver assistance system comprises a control unit for processing sensor signals which is configured to process sensor signals of at least one environment sensor of the motor vehicle, wherein the environment sensor is configured to detect environmental information and convert it into sensor signals. The system comprises a vehicle test bench configured to operate at least one drive train of the motor vehicle, with at least one simulation module, whereby the simulation module incorporates at least one environment sensor and comprises a stimulation device allocated to said environment sensor. In particular, an environment sensor is an arrangement of multiple environment sensors, wherein said arrangement is allocated a single simulation device or each of the individual environment sensors of the arrangement are allocated a simulation device. The environment sensor incorporated by the simulation module corresponds, particularly in functional and/or structural terms, to the environment sensor of the motor vehicle or is the environment sensor of the motor vehicle. The simulation module is connected to the vehicle test bench for signal transmission in order to transmit a sensor signal from the simulation module to the control unit of the driver assistance system. This signal transmission connection is in particular designed as a direct connection or an indirect one by way of a simulation platform or simulation interface respectively. Preferentially, the signaling connection is ensured via an integration platform.

A second aspect of the invention relates to a method for testing a driver assistance system of a motor vehicle on a vehicle test bench comprising the steps of simulating a test environment via at least one simulation module; generating a sensor signal by means of the at least one simulation module for processing by a control unit of the driver assistance system instead of a sensor signal of at least one environment sensor of the motor vehicle preferably fixed on or in the motor vehicle (3). Furthermore, the method comprises the step of operating at least one of the drive trains of the motor vehicle on the vehicle test bench on the basis of the sensor signal using the driver assistance system.

A third aspect of the invention relates to a method for testing a driver assistance system of a motor vehicle on a test track, comprising the following steps:

simulating a test environment by means of at least one simulation module;

generating a sensor signal via the at least one simulation module for processing by a control unit of the driver assistance system instead of a sensor signal of at least one environment sensor of the motor vehicle; and

operating the motor vehicle on the test track based on the sensor signal generated by means of the at least one simulation module using the driver assistance system.

An environment sensor within the meaning of the invention is in particular an apparatus for detecting and/or measuring physical variables within its environment, particularly the surroundings of the motor vehicle. Preferably, the environment sensor is configured to survey, in particular scan, the environment or surroundings respectively of the motor vehicle. The environment sensor preferably comprises a receiver and a signal converter, wherein the receiver is preferably directly responsive to the physical or chemical measured variable, or respectively quantitatively and/or qualitatively detects its property, and the signal converter converts said detected property into a preferably electrically transmissible signal.

The environment sensor is preferably designed as an active sensor, particularly as an infrared camera, ultrasonic sensor, radar sensor and/or lidar sensor and is in particular configured to emit sound waves or respectively electromagnetic waves and to receive sound waves or respectively electromagnetic waves influenced by the environment or the motor vehicle's surroundings respectively, in particular as reflected by objects. Further preferential is the designing of an environment sensor as a passive sensor, respectively receiver, particularly as a camera or GPS receiver. The environment sensor is preferably configured to generate a sensor signal on the basis of a received measurement signal, in particular a response signal of the stimulation device characterizing the measurement signal and/or the information it contains.

A simulation module within the meaning of the invention in particular comprises an environment sensor and a stimulation device allocated thereto. The stimulation device is preferably configured to provide a measurement signal, in particular a response signal and/or a measured variable, to its associated environment sensor. Particularly an environment is simulated by means of the measurement signal generated or respectively modulated by the stimulation device, preferably an environment of the vehicle or a driving situation of the motor vehicle. This measurement signal is preferably characterized by a physical measured variable which in turn is preferably detected by the receiver of the environment sensor and converted into a sensor signal by the signal converter of the environment sensor. Preferably, at least one stimulation device is allocated to each environment sensor of a simulation module, particularly preferentially in a one-to-one allocation, in order to enable the providing of the most specific measurement signal or respectively response signal possible for the environment sensor.

A driver assistance system within the meaning of the invention is preferably a system for assisted driving, a system for partially automated driving, a system for highly automated driving, a system for fully automated driving, or a system for autonomous driving; in particular, said respective systems for automated driving correspond to the classification and/or definition of the SAE J3016 standard.

A vehicle test bench within the meaning of the invention is in particular configured to operate a drive train of the motor vehicle and/or parts thereof, or components of the motor vehicle or the motor vehicle respectively, in particular the motor vehicle's steering. Preferably, the vehicle test bench is a roller dynamometer or a drive train test bench. A real-world driving situation is preferably simulated during the operating of the drive train and/or motor vehicle on the vehicle test bench. Particularly depicted, or respectively simulated, is a real-world operation of the motor vehicle, in particular the physical forces and environmental conditions to which a motor vehicle is subjected during actual driving. Accordingly, forces transmitted or able to be transmitted to a stimulation unit arranged on the motor vehicle act on the motor vehicle on the vehicle test bench. This can thereby result in damage to particularly sensitive components of stimulation devices or vibrations which adversely affect signal transmission between the stimulation unit and its associated environment sensor.

The invention is in particular based on the approach of operating the driver assistance system in a motor vehicle on the vehicle test bench at least to some extent on the basis of sensor signals which characterize a simulated environment or a simulated traffic scenario respectively. Preferably, the sensor signals which are processed by the control unit of the driver assistance system are generated by the simulation module. The simulation module thereby realizes the simulating of the environment/driving situation, particularly the generating of the sensor signal. In particular, the sensor signal is depicted by the environment sensor incorporated by the simulation module and at least not solely by the environment sensors arranged in or on the motor vehicle. Preferably, a system according to the invention comprises a plurality of simulation modules, the environment sensors of which are preferably based on different measuring principles. A system designed as such offers a high degree of flexibility and the possibility of comprehensively testing a driver assistance system.

Particularly when simulating an environment based on sensor signals from multiple environment sensors, one stimulation unit can be allocated to each respective environment sensor. Due to the limited spatial conditions on or around a motor vehicle to be tested on the vehicle test bench, it is difficult to install multiple stimulation units, especially when the various stimulation units each comprise associated shielding apparatus or there is only limited accessibility to the environment sensors.

The inventive simulation module is preferably designed as a separate structural unit of the preferably modular system which is able to be positioned and operated independently of the motor vehicle or the vehicle test bench respectively. The simulation module enables the sensor signal to be preferably generated spatially independent of the physical or respectively in-use position of the environment sensor. Due to the physical, in particular spatial, decoupling of the simulation module from the motor vehicle, the simulation module in particular improves the simulating of the environment. This thus makes it possible to in particular operate and/or test the motor vehicle on the vehicle test bench without any modifications, particularly without any additions or superstructures relative to stimulation units for environment sensors.

In one preferential embodiment, the simulation module is designed to generate sensor signals to depict environmental information from the perspective of the motor vehicle's environment sensor. The control unit is thereby provided with a particularly precise simulation of an environment for processing. Such sensor signals preferably contain information about interactions with other environment sensors of the motor vehicle. The testing of environment sensors, particularly individual environment sensors, or their influence on the driver assistance system respectively, can thus be depicted particularly realistically.

In a further preferential embodiment, the simulation module is connected to the vehicle test bench, in particular the control unit, solely by means of a connection for signal transmission. Preferably, this connection is realized in the form of one or more cables, a bus system, in particular a field bus, or by means of a wireless connection for data transmission. No additional interface is thus needed for signal transmission.

This thereby enables a physical, in particular spatial, separation of the simulation module and the vehicle test bench. In so doing, transmission of motion, particularly impacts or vibrations, from the motor vehicle or respectively vehicle test bench to the simulation module can be avoided or even completely prevented. The stimulation device's stimulation of the environment sensor of the simulation module can thus ensue without physical detriment, the environment sensor detecting the measurement signal emitted by the stimulation device preferably without interference and a sensor signal thus being generated which reproduces, preferably unadulterated, the simulated environmental scenario.

In a further preferential embodiment, the environment sensor incorporated by the simulation module is identical to the environment sensor of the driver assistance system it replaces. An identical environment sensor providing the sensor signal provided to the control unit for processing ensures particularly realistic signal quality in the context of testing. In particular, the environment sensor incorporated by the simulation module is of structurally identical design and/or at least functionally identical to the environment sensor of the driver assistance system it replaces.

In a further preferential embodiment, the system comprises at least two simulation modules, wherein at least two of said simulation modules differ in the measuring principle applied by their incorporated environment sensors. Using different simulation modules enables testing the individual environment sensors and their influence on the driver assistance system, in particular independently of one another. Reciprocal influence and/or interactions of environment sensors, which come into effect in particular due to measuring range interference and overlap, can thus be reduced or even prevented or systematically analyzed.

Similarly, it can be provided for a system to make use of multiple simulation modules based on the same, different, or a combination of same and different measuring principles.

In a further preferential embodiment, the at least one simulation module comprises at least two environment sensors, wherein two of said environment sensors differ in the measuring principle they apply. When using two or more environment sensors, particularly when they are based on different measuring principles and in particular when the environment sensor is actively emitting a signal, measuring ranges can overlap and interactions and/or reciprocal, particularly undesirable, interference can occur. In order to factor for this reciprocal influence during testing of the driver assistance system, it can be advantageous with respect to depicting the interactions for said environment sensors to be arranged in relatively close proximity in a single simulation module.

Provision can further be made to provide environment sensors based on the same, similar and/or different combinations thereof in its own simulation module in order to authentically depict or respectively factor in their interactions on and with one another during testing of the driver assistance system.

In a further preferential embodiment, the at least one environment sensor is arranged and/or integrated in a component, in particular a component of the motor vehicle, preferably the body of the motor vehicle, with said component able to be incorporated by the at least one simulation module. Such a component can be detached, in particular as a whole, from a motor vehicle to be tested and mounted in or on a simulation module. Alternatively, a second, in particular structurally identical, component can be mounted in or on the simulation module.

Such a configuration to the simulation module enables a particularly realistic depiction of an environment by means of the generated sensor signals, since interactions and structural specifics resulting in particular from the specific positioning of the environment sensors in or on the component are depicted and taken into account by the control unit during processing. Environment sensors can also be arranged in components so as to be inaccessible or not readily accessible when installed in the motor vehicle, particularly for stimulation by a stimulation device. Detaching the component from the motor vehicle or providing a structurally identical copy of the component and using said component as an environment sensor of the simulation module can facilitate the allocating or positioning of the at least one stimulation device.

In a further preferential embodiment, the simulation module, particularly the environment sensor incorporated by the stimulation device and the stimulation device, is realized as a structural unit, preferably covered by a housing. Preferably, a simulation module exhibits a material which is particularly suited to absorbing a signal emitted by an environment sensor so as to absorb signals emitted by the environment sensor not directly impinging the stimulation device. Further preferably, the simulation module has a shielded design so as to diminish, preferably prevent, propagation of the measurement signal beyond the simulation module. This thereby facilitates an individual, unadulterated consideration of the individual sensor signals generated. Additionally simplified is the using of one, multiple or different simulation modules within the system since they can be positioned more easily as a structural unit and operated independently of one another.

In a further preferential embodiment, the stimulation device is configured to generate a response signal, preferably based on a signal emitted by the at least one environment sensor incorporated by the simulation device, to be received by said environment sensor, whereby the response signal is preferably generated on the basis of a simulated test environment.

In a further preferential embodiment, the system comprises at least one signal converter, in particular a perception chip of a camera of at least one further environment sensor. The signal converter is configured to transmit a sensor signal to the control device of the motor vehicle and to generate the sensor signal on the basis of raw sensor data, wherein the raw sensor data is fed into the signal converter and same generates the sensor signal. Preferably, raw sensor data is transmitted to the signal converter, whereby the raw sensor data contains information characterizing the simulated environment to be processed by the signal converter. An environment sensor typically comprises a receiver which detects the measured variable as a physical variable and provides this measurement to the signal converter, particularly in the form of raw sensor data, in order to generate a sensor signal. When raw sensor data is provided directly to the signal converter for conversion, an environment sensor receiver as well as a stimulation device for the environment sensor can be dispensed with. For example, a raw image, in particular comprising image data from a simulation, can be transmitted directly to the perception chip of a camera for processing. Camera optics for image recordal can thus be dispensed with. The sensor signal can thereby be generated and/or provided for the control unit in a particularly simple manner.

In a further preferential embodiment, the system comprises at least one apparatus configured to generate a simulated sensor signal, particularly in the form of object lists and/or object data, and transmit same to the control unit of the driver assistance system. It is thus possible to directly provide information relating to the simulated environment to the control unit. To put it another way, the environment sensor is simulated. A system designed as such thus offers a simple, in particular additional, possibility for transmitting information to the control unit for operating the driver assistance system in the form of simulated sensor signals so as to depict complex environmental scenarios in a simple manner.

In one preferential embodiment, the method comprises the further steps of mounting at least one environment sensor on or in the at least one simulation module and allocating a stimulation device to said environment sensor. In particular, an identical environment sensor to the environment sensor of the motor vehicle can be installed in order to provide the most authentic possible sensor signal for the control device. The mounting and allocating of the environment sensor and stimulation device makes the method particularly flexible and individually adaptable to test requirements. In particular, in an optional further step, the at least one environment sensor and/or the at least one stimulation device is/are calibrated and/or the at least one stimulation device is aligned with respect to the at least one environment sensor, or vice versa, in order to achieve an optimal and realistic stimulation of the environment sensor(s).

In a further preferential embodiment, the method comprises the step of mounting in or on the at least one simulation module a component, in particular a component of the motor vehicle, which has at least one environment sensor arranged and/or integrated therein. Using components of the vehicle to generate a sensor signal enables particularly realistic depictions of interactions, particularly between the component and the environment sensor(s) fixed therein or thereon. In particular, a component of the motor vehicle, such as a bumper with integrated environment sensors for example, can be mounted in the simulation module in order to particularly precisely depict the simulated environment.

In a further preferential embodiment, the method comprises the step of detaching a component of the motor vehicle having at least one environment sensor arranged and/or integrated therein from the motor vehicle in order to enable said component to be mounted in the simulation module. Using the component with the environment sensor(s) of the motor vehicle as an environment sensor of the simulation module enables the particularly simple providing of an environment sensor for the simulation module.

In a further preferential embodiment, a method according to the invention comprises the step of suppressing a signal transmission of the environment sensor of the motor vehicle to the control device. To this end, the environment sensor of the motor vehicle can be disconnected, muted and/or a corresponding input and/or connection of the control unit muted. The sensor signal of the simulation module is preferably transmitted to the control unit instead of a sensor signal of the motor vehicle environment sensor it replaces. Suppressing the signal transmission of the motor vehicle's environment sensor prevents accidental or unwanted signal transmissions by said environment sensor.

In a further preferential embodiment. the environment sensor is the environment sensor of the motor vehicle.

The features and advantages described in relation to the first aspect of the invention and its advantageous embodiment also apply accordingly to the second aspect of the invention and its advantageous embodiment, at least where same makes technical sense, and vice versa.

The invention will be explained in greater detail below on the basis of non-limiting exemplary embodiments as illustrated in the figures. Shown therein at least partly schematically:

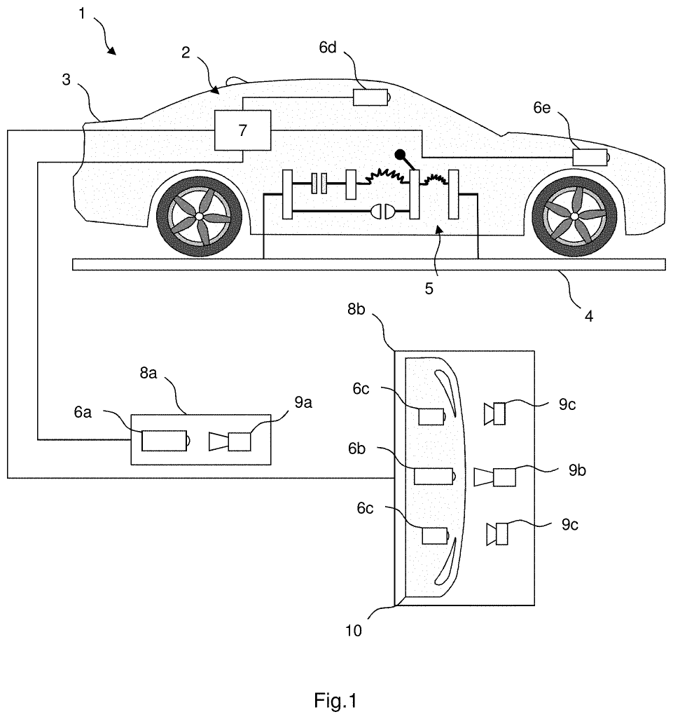

FIG. 1 a preferential exemplary embodiment of a system for testing a driver assistance system of a motor vehicle; and

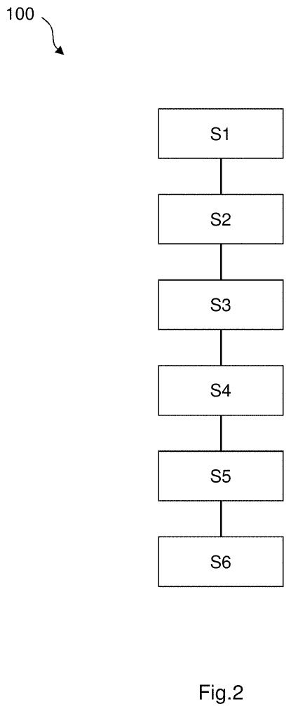

FIG. 2 a preferential exemplary embodiment of a method for testing a driver assistance system of a motor vehicle on a vehicle test bench.

FIG. 1 shows a system 1 for testing a driver assistance system 2 of a motor vehicle 3. The motor vehicle 3 is arranged on a vehicle test bench 4 which is configured to operate at least one drive train 5 of the motor vehicle 3. In particular, the vehicle test bench 4 is configured to operate the motor vehicle 3 or components of the motor vehicle 3 using the driver assistance system 2. The vehicle test bench 4 is preferably a roller dynamometer or a drive train test bench having a wheel emulation device. Such a test bench further comprises a weather simulator having a temperature control device and an airflow emulation device.

The motor vehicle 3 can be operated under precisely controlled conditions with the vehicle test bench 4. For example, a torque can be applied to the rotatably mounted wheel emulation device, whereby different loads of the motor vehicle 3, different road conditions and/or the like can be simulated. Alternatively or additionally, different weather conditions can be simulated, for instance by the temperature control device providing different temperatures and/or the airflow emulation device providing different wind flows.

In order to detect the environment, the motor vehicle 3 comprises at least one environment sensor 6d, 6e configured to detect a physical measured variable, in particular a measurement signal, and convert it into a sensor signal. An environment sensor 6a, 6b, 6c, 6d, 6e, in particular of the motor vehicle 3, is preferably designed as an ultrasonic sensor, a radar sensor, a lidar sensor, a camera or as a GPS receiver. In the exemplary embodiment as depicted, for example, the motor vehicle 3 exhibits a camera 6d and a radar sensor 6e.

Preferably, the environment sensor 6a, 6b, 6c, 6d, 6e is configured to emit a measurement signal, preferably sound waves or electromagnetic waves, for detecting the environment. This measurement signal, e.g. an ultrasonic signal, interacts with the environment and is thereby influenced by the environment. The impacted measurement signal can be received or respectively detected by the at least one environment sensor and a sensor signal generated on the basis thereof which characterizes the environment of the motor vehicle 3. The interaction thereby corresponds to, for example, a reflection, a transmission and/or an at least partial absorption of the measurement signal at or respectively by objects in the vicinity of the motor vehicle 3.

In FIG. 1, a control unit 7 of the driver assistance system 2 is for example connected to a first environment sensor 6d of the motor vehicle 3 and a second environment sensor 6e of the motor vehicle 3. In order to be able to analyze the driver assistance system 2 in a precisely controlled environment, a first simulation module 8a and a second simulation module 8b are connected to the control unit 7 in order to simulate an environmental scenario for the driver assistance system, in particular a vehicle environment or a driving situation respectively. The first simulation module 8a comprises a first environment sensor 6a and a first stimulation device 9a allocated thereto. The second simulation module 8b comprises a second environment sensor 6b having a second stimulation device 9b allocated thereto and two third environment sensors 6c having two third stimulation devices 9c allocated thereto.

The control unit 7 is configured to process the sensor signals of at least one environment sensor 6a, 6b, 6c, 6d, 6e. A signal transmission connection between the control unit 7 and the environment sensors 6a, 6b, 6c, 6d, 6e can be of wireless or wired design. Preferentially, the at least one environment sensor 6a, 6b, 6c, 6d, 6e is connected to the control unit 7 by means of a bus system, further preferentially by means of a field bus. The stimulation device 9a, 9b, 9c is configured to stimulate the environment sensor 6a, 6b, 6c such that the sensor signal it generates simulates interactions of the motor vehicle 3 with its surroundings and/or influences of the surroundings on the motor vehicle 3. To that end, the stimulation device 9a, 9b, 9c can influence a measurement signal, in particular one emitted by the environment sensor 6a, 6b, 6c, or provide a measurement signal to be detected by said environment sensor 6a, 6b, 6c. The sensor signal of the environment sensor 6a, 6b, 6c of the simulation module 8a, 8b preferably replaces the sensor signal of the environment sensor 6d, 6e of the motor vehicle 3 for processing by the control unit 7. The simulation module 8a, 8b is arranged and able to be operated independently, in particular at a distance, particularly in a different room, from the motor vehicle 3 and/or the vehicle test bench 4. In a further preferential exemplary embodiment, the vehicle test bench 4 is arranged in a test cell and the simulation module(s) 8a, 8b arranged outside of said test cell. In particular, components and/or simulation modules of the system can be entirely separate geographically as part of a so-called networked test bench, e.g. even arranged in different countries.

Preferably, the simulation module 8a, 8b is exclusively connected to the control unit 7 via a data connection. In particular, the simulation module 8a, 8b is arranged relative to the motor vehicle 3 and/or the vehicle test bench such that motion and/or forces arising when the motor vehicle 3 is operated by the vehicle test bench 4 are not transmitted to the simulation module 8a, 8b. This thereby protects the environment sensor 6a, 6b, 6c and associated, particularly highly sensitive stimulation device 9a, 9b, 9c of the simulation module 8a, 9a from physical interference due to forces and motions of the motor vehicle 3 or the vehicle test bench 4.

Preferably, the simulation module 8a, 8b fully incorporates the at least one environment sensor 6a, 6b, 6c and the at least one associated stimulation device 9a, 9b, 9c or has a housing in which the at least one environment sensor 6a, 6b, 6c and the at least one associated stimulation device 9a, 9b, 9c are arranged. This thereby protects the simulation module 8a, 8b, particularly the sensitive stimulation device 9a, 9b, 9c, from dirt and moisture. Preferably, the simulation module 8a, 8b exhibits an absorber, in particular in the form of a signal-absorbing coating, which is designed to absorb measurement signals and/or insulate the components of the simulation module 8a, 8b.

In the exemplary embodiment as shown, the first environment sensor 6d of the motor vehicle 3 is designed as a camera. In order to depict an environmental simulation based on sensor signals and replace the sensor signals of the motor vehicle 3 camera 6d for the control unit 7, the first environment sensor 6a of the first simulation module 8a is likewise designed as a camera, particularly an identical camera. The first stimulation device 9a is allocated to said camera 6a, preferably in such a manner as to maintain a necessary minimum distance for camera stimulation. The stimulation device 9a is thereby configured to provide the camera 6a with a simulated image of the environment, particularly for detection by the optics of the camera 6a. The camera 6a is configured to record the environmental image and convert it into a sensor signal. This sensor signal can then be processed by the control device 7 instead of the sensor signal of the motor vehicle 3 camera 6d.

In a further preferential exemplary embodiment, the environment sensor 6d of the motor vehicle 3 is designed as a stereo camera having two lenses. Preferentially, a similar, in particular identical, stereo camera 6a, 6b, 6c is arranged in a simulation module 8a, 8b, whereby one respective stimulation device 9a, 9b, 9c is allocated to each of the two lenses of the stereo camera. By providing the stereo camera in a simulation module 8a, 8b, the stimulation devices 9a, 9b, 9c can be suitably allocated to both lenses of the stereo camera without needing to take into account the installation circumstances on the motor vehicle 3. The second simulation module 8b comprises a component 10, a bumper in the present exemplary embodiment, mounted in the simulation module 8b. Three environment sensors 6b, 6c are arranged in the bumper 10, each of which is allocated an applicative stimulation device 9b, 9c. For example, the two outer environment sensors 6c are designed as environment sensors according to a first measuring principle, in particular as radar sensors, the inner environment sensor 6b being designed as an environment sensor according to a second measuring principle, in particular as a lidar sensor.

The bumper 10 which is mounted in the second simulation module is preferably a bumper for the motor vehicle 3 on the vehicle test bench 4, in particular equipped with structurally and/or functionally similar, preferably identical, environment sensors 6b, 6c as the bumper of the motor vehicle 3.

Alternatively or additionally, it can also be provided for the detaching of the bumper 10 and/or another component 10 of the motor vehicle 3 located on the vehicle test bench 4, in particular together with the environment sensors 6e provided therein, and the mounting of said component 10 in or on the second sensor module 8b, in particular together with the environment sensors 6b, 6c provided therein.

The use of installed environment sensors 6a, 6b, 6c, 6d, 6e, in particular in the relevant component 10 such as in the motor vehicle 3, particularly enables a realistic analysis of interactions between individual environment sensors 6a, 6b, 6c, 6d, 6e or sensor systems of multiple environment sensors 6a, 6b, 6c, 6d, 6e respectively.

In a further exemplary embodiment, the system can comprise a plurality of simulation modules 8b equipped with the same components 10, in particular a plurality of environment sensors 6b, 6c. Consequently, this for example enables only environment sensors 6b according to a first measuring principle to be provided and/or operated in a first simulation module 6b and only environment sensors 6c according to a second measuring principle to be provided and/or operated in a second simulation module 8b. This can thereby in particular prevent interactions of the environment sensors 6b, 6c, particularly within one stimulation device 9b, and thus simulation errors.

In principle, combinations of any number of in particular differently designed simulation modules 8a, 8b are conceivable in further exemplary embodiments of a system 1 according to the invention in order to enable comprehensive testing of the driver assistance system 2.

In a further exemplary embodiment, the simulation module 8a, 8b is not used on the vehicle test bench but rather on a test track. In this case, the simulation module 8a, 8b can preferably be arranged in the interior of the motor vehicle 3, particularly in the trunk.

FIG. 2 shows a preferential exemplary embodiment of a method 100 according to the invention for testing a driver assistance system 2 of a motor vehicle 3.

In an optional method step S1, at least one component 10 of the motor vehicle 3 comprising at least one environment sensor 6d, 6e arranged and/or integrated therein is detached from the motor vehicle 3 in order to enable said component 10 to be mounted in the simulation module 8a, 8b. This step S1 can be dispensed with if no component 10 or a component 10 not from the motor vehicle 3 is to be mounted in the simulation module 8. Alternatively or additionally able to be provided for is the detaching of an environment sensor 6d, 6e of the motor vehicle 3.

In a method step S2, a component 10, preferentially a component 10 of the motor vehicle 3, particularly preferentially the component 10 which was detached from the motor vehicle 3 in method step S1, is mounted in or on the at least one simulation module 8a, 8b. The component 10 thereby comprises at least one environment sensor 6a, 6b, 6c, 6d, 6e arranged and/or integrated therein.

Alternatively or additionally, at least one environment sensor 6a, 6b, 6c, 6d, 6e which is not integrated into a component 10 is mounted on or in the at least one simulation module 8a, 8b. In particular, each of the environment sensors 6a, 6b, 6c mounted in the simulation module 8a, 8b is or is to be connected to the control unit 7 for the transmission of sensor signals.

If only environment sensors 6a, 6b, 6c which are not those of the motor vehicle 3 are mounted in the simulation module 8a, 8b, the corresponding environment sensors 6d, 6e of the motor vehicle 3 can then be disabled. In other words, those environment sensors 6d, 6e with sensor signals replaced via the simulation module 8a, 8b can be disconnected from the control unit 7 or said sensor signals can be muted in terms of the control unit 7 processing. This thereby enables minimizing interference of the environment sensors 6d, 6e of the motor vehicle 3 on the control unit 7 and thus on the driver assistance system 2. In a method step S3, the at least one environment sensor 6a, 6b, 6c mounted in the simulation module 8a, 8b is allocated a stimulation device 9a, 9b, 9c. Preferably, each environment sensor 6a, 6b, 6c in the simulation module 8a, 8b is allocated a stimulation device 9a, 9b, 9c. Alternatively, one stimulation device 9a, 9b can be allocated to multiple environment sensors 6a, 6b, 6c, particularly environment sensors 6a, 6b, 6c based on the same measuring principle, in order to stimulate same. Functionally allocating the stimulation device 9a, 9b, 9c to the environment sensor 6a, 6b, 6c is simplified due to the environment sensor 6a, 6b, 6c being arranged in the simulation module 8a, 8b in freely accessible manner, in particular not being obscured when integrated into the motor vehicle 3. A precise alignment of environment sensor 6a, 6b, 6c and stimulation device 9a, 9b, 9c is thus possible.

Preferably, the at least one environment sensor 6a, 6b, 6c and/or stimulation device 9a, 9b, 9c is/are calibrated in an optional further step. Calibration within the meaning of the invention means comparing a measured value displayed by an environment sensor 6a, 6b, 6c to a preset reference value. The calibration in particular includes a documentation of measurement deviation and a calculation of measurement uncertainty and preferably ensues under predetermined reference conditions. Preferably, no technical interventions relative the environment sensor 6a, 6b, 6c and/or the stimulation device 9a, 9b, 9c are thereby required. Further preferentially, in order to achieve an optimal operating position, the at least one stimulation device 9a, 9b, 9c is spatially adjusted/aligned relative to the at least one environment sensor 6a, 6b, 6c, or vice versa, in an optional further step.

In a method step S4, a test environment is simulated via at least one simulation module 8a, 8b. The at least one environment sensor 6a, 6b, 6c of the at least one simulation module 8a, 8b is stimulated on the basis of a simulated environmental scenario. To that end, the stimulation device 9a, 9b, 9c preferably modulates a measurement signal emitted by the environment sensor 6a, 6b, 6c and provides it to the environment sensor(s) 6a, 6b, 6c for detection. Alternatively, the stimulation device 9a, 9b, 9c can provide a measurement signal as a measurement signal for simulating an environmental scenario, for example in the form of GPS data or a simulated image. In particular, the stimulation device 9a, 9b, 9c is configured to stimulate the environment sensor(s) 6a, 6b, 6c in such a way as to depict the surroundings thereof from the perspective of the environment sensor 6d, 6e of the motor vehicle 3.

In a further method step S5, a sensor signal for processing by a control unit 7 of the driver assistance system 2 is generated. This sensor signal is generated by means of the at least one simulation module 8a, 8b and processed by the control unit 7 instead of a sensor signal from at least one environment sensor 6d, 6e of the motor vehicle 3. The at least one simulation module 8a, 8b can thus generate sensor signals which characterize the simulated environmental scenario.

In a further method step S6, at least one drive train 5 of the motor vehicle 3 is operated on the vehicle test bench 4 on the basis of the at least one sensor signal of the at least one sensor module 8a, 8b using the driver assistance system 2. Alternatively, the motor vehicle 3 is operated on a test track on the basis of the at least one sensor signal of the at least one sensor module 8a, 8b using the driver assistance system 2. In both cases, additional further sensor signals can be generated by actual and/or simulated sensors and used for processing by the control unit 7 and preferably for operating the driver assistance system 2 and/or drive train 5 and/or motor vehicle 3.

Additionally to be noted is that the exemplary embodiments are only examples that are not intended to limit the scope of protection, the applications and configuration in any way. Rather, the foregoing description is to provide the person skilled in the art with a guideline for implementing at least one exemplary embodiment, whereby various modifications can be made, particularly as regards the function and arrangement of the described components, without departing from the scope of protection resulting from the claims and such equivalent combinations of features.

### LIST OF REFERENCE NUMERALS

1 system
2 driver assistance system
3 motor vehicle
4 vehicle test bench
5 drive train
6a, 6b, 6c,6d, 6e environment sensor
7 control unit
8a, 8b simulation module
9a, 9b, 9c stimulation device
10 component
S1 component detaching
S2 environment sensor mounting
S3 stimulation device allocation
S4 test environment simulation
S5 sensor signal generation
S6 drive train operation

What is claimed is:

1. A system for testing a driver assistance system of a motor vehicle,
wherein the driver assistance system comprises a control unit for processing sensor signals configured to process sensor signals of at least one environment sensor of the motor vehicle, wherein the at least one environment sensor is configured to detect environmental information and convert it into sensor signals,
wherein the system comprises:
a vehicle test bench configured such that a drive train of the motor vehicle can be operated; and
at least one simulation module, wherein the simulation module incorporates or can incorporate at least one environment sensor and comprises a stimulation device allocated to said environment sensor;
wherein the environment sensor incorporated or able to be incorporated by the simulation module corresponds, in particular functionally and/or structurally, to the at least one environment sensor of the motor vehicle or is the at least one environment sensor of the motor vehicle; and
wherein the simulation module is connected to the vehicle test bench for signal transmission in order to transmit a sensor signal from the simulation module to the control unit of the driver assistance system.

2. The system according to claim 1, wherein the simulation module is designed to generate sensor signals which depict the environmental information from the perspective of the environment sensor of the motor vehicle.

3. The system according to claim 1, wherein the simulation module is connected to the vehicle test bench, in particular the control unit, solely by means of a connection for signal transmission, preferably by means of a cable, a bus system, in particular a field bus, or by means of a wireless connection.

4. The system according to claim 1, wherein the environment sensor which is or can be incorporated by the simulation module is identical to the environment sensor of the driver assistance system it replaces.

5. The system according to claim 1, wherein the system comprises or can incorporate at least two simulation modules, wherein at least two of said simulation modules differ in the measuring principle applied by their incorporated environment sensors.

6. The system according to claim 1, wherein the at least one simulation module comprises or can incorporate at least two environment sensors, wherein at least two of said environment sensors differ in the measuring principle they apply.

7. The system according to claim 1, wherein the at least one environment sensor is arranged and/or integrated in a component, in particular a component of the motor vehicle, preferably the body of the motor vehicle, and said component is or can be incorporated by the at least one simulation module.

8. The system according to claim 1, wherein the simulation module, particularly the environment sensor which is or can be incorporated by the simulation module and the stimulation device, is/are realized as a structural unit, preferably covered by a housing.

9. The system according to claim 1, wherein the stimulation device is configured to generate a response signal, preferably based on a signal emitted by the at least one environment sensor incorporated by the simulation device, to be received by said environment sensor, wherein the response signal is preferably generated on the basis of a simulated test environment.

10. The system according to claim 1, wherein the system comprises at least one signal converter, in particular a perception chip of a camera of at least one further environment sensor, which is configured to transmit a sensor signal to the control device of the motor vehicle and to generate the sensor signal on the basis of raw sensor data, wherein the raw sensor data is fed into the signal converter and same generates the sensor signal.

11. The system according to claim 1, wherein the system comprises at least one apparatus configured to generate a simulated sensor signal, particularly in the form of object lists and/or object data, and transmit same to the control unit of the driver assistance system.

12. A method for testing a driver assistance system of a motor vehicle on a vehicle test bench, particularly using a system according to one of the preceding claims, comprising the following steps:
simulating a test environment via at least one simulation module;
generating a sensor signal by means of the at least one simulation module for processing by a control unit of the driver assistance system instead of a sensor signal of at least one environment sensor of the motor vehicle; and
operating a drive train of the motor vehicle on the vehicle test bench based on the sensor signal generated via the at least one simulation module using the driver assistance system.

13. A method for testing a driver assistance system of a motor vehicle on a test track, comprising the following steps:
simulating a test environment by means of at least one simulation module;
generating a sensor signal via the at least one simulation module for processing by a control unit of the driver assistance system instead of a sensor signal of at least one environment sensor of the motor vehicle; and
operating the motor vehicle on the test track based on the sensor signal generated by means of the at least one simulation module using the driver assistance system.

14. The method according to claim 12, additionally comprising the steps:
mounting at least one environment sensor on or in the at least one simulation module; and
allocating a stimulation device to said environment sensor.

15. The method according to claim 12, comprising the step:
mounting a component, in particular a component of the motor vehicle, having at least one environment sensor arranged and/or integrated therein, in or on the at least one simulation module.

16. The method according to claim 15, additionally comprising the step:
detaching a component of the motor vehicle having at least one environment sensor arranged and/or integrated therein from the motor vehicle in order to enable said component to be mounted in the simulation module.

17. The method according to claim 12, additionally comprising the step:
suppressing a signal transmission of the environment sensor of the motor vehicle to the control device.

18. The method according to claim 12, wherein the environment sensor is the environment sensor of the motor vehicle.

19. The method according to claim 12, wherein the simulation module incorporates or can incorporate the environment sensor and a stimulation device and is realized as a structural unit, preferably covered by a housing.
